(19) United States
(12) Patent Application Publication
(10) Pub. No.: US 2020/0051172 A1
(43) Pub. Date: Feb. 13, 2020

(54) METHOD AND SYSTEM FOR CREATING A LEGAL CASEFILE

(71) Applicant: VICTOR NATIONAL HOLDINGS, INC., Columbus, GA (US)

(72) Inventors: John Michael Agnew, Columbus, GA (US); Guillermo W A. Handal, Columbus, GA (US); Deborah Suzanne Bryan, Columbus, GA (US)

(21) Appl. No.: 16/359,937

(22) Filed: Mar. 20, 2019

Related U.S. Application Data
(60) Provisional application No. 62/645,665, filed on Mar. 20, 2018.

(51) Int. Cl. G06Q 40/08; G06F 16/25; G06F 16/958; G06Q 30/02; G06Q 10/10; G06Q 50/22

(52) U.S. Cl. CPC G06Q 40/08; G06F 16/252; G06Q 50/22; G06Q 30/02; G06Q 10/10; G06F 16/972

(57) ABSTRACT

A computer-implemented method for preparing a legal casefile for an injury in which the injured is surveyed, information about the accident is transformed and aggregated, and a report is created based on the analysis of all of the information.

### TECHNICAL FIELD

This application relates with processing of unstructured data and processing data used in law practices and by person seeking law professionals. More specifically, this application relates to transforming unstructured data into structured data to facilitate workflow management. This application also relates to computer systems and methods, and more particularly to such systems and methods for work management and the like.

### BACKGROUND

The information needed to assess the legal claim for a personal injury, e.g., in an accident is extensive and includes gather information such as police reports, motor vehicle reports, ambulance reports, property damage reports doctor and hospital bills, prior medical records, final medical reports, medical reports, and witness statements. The current process for collecting such information, identifying the facts, and tracking the progress of personal injury claims is extensive. To determine whether there is a claim against a third party for injuries, it is necessary to determine who is at fault for causing the injuries, were the injuries caused by the events, and what insurance is available for recovery.

In general, the information is gathered by (1) interviewing a patient, (2) collecting evidence, physical or any other type of evidence (e.g., through an accident report), (3) determining whether there is a responsible party or suitable insurance coverage, (4) potentially sending a demand letter; and (5) ultimately trying or settling the case. All of these steps are scattered, disjointed, time consuming, and expensive. As a result, it is often difficult for injured parties to obtain relief for minor injuries.

Accordingly, there is a need for streamlined process for gathering and organizing the workflow around a personal injury case. It is to this need, among others, that this application is directed.

### SUMMARY

According to some embodiments, systems, methods, apparatus, computer program code and means may facilitate workflow for preparing a casefile in injury cases or claims. This application discloses methods and systems for preparing and a legal casefile for an injury case. One embodiment includes querying a user who may have a claim against a third party for the injury from accident; surveying the user about the operative facts about the injury and accident, seeking permission from the user to collect the information related to the injury and accident from third party sources; aggregating the information; transforming the information from the sources into structured data for legal analysis; analyzing the structured data to determine insurance coverage and to coordinate the insurance coverage; reconciling the operative facts with the structured data using an algorithm that weights facts based on historical data, historical correlations, and legal principles; identifying potential liability of the third party from the facts; and creating a report to manage client and case information, to facilitate legal processing of a case or claim against the third party. The report can include liability analysis, insurance coverage, medical information, and medical analysis. The liability analysis includes correlations of facts or specific facts in the structured data. The medical information includes correlation of medical facts or specific medical facts in the structured data.

Another embodiment includes a computerized-method for preparing and legal casefile for an injury and accident, comprising the steps of surveying the user about the operative facts about the injury and accident; aggregating information; transforming the information from the sources into structured data for legal analysis; analyzing the structured data to determine insurance coverage and to coordinate the insurance coverage; reconciling the operative facts with the structured data using an algorithm that weights facts based on historical data, historical correlations, and legal principles; identifying significant data that include (1) potential liability of the third party from the structured data, (2) follow-up medical care from the structured data, (3) any pain and suffering by the user/injured/patient/client (of attorney), and (4) special damages from the structured data; preparing a first report that includes the significant data so that an attorney may confirm the significant facts with the user; and preparing a second report that identifies probability of a financial outcome based on historical data of settlement and verdicts and based statistical analysis.

### DETAILED DESCRIPTION OF THE DRAWINGS

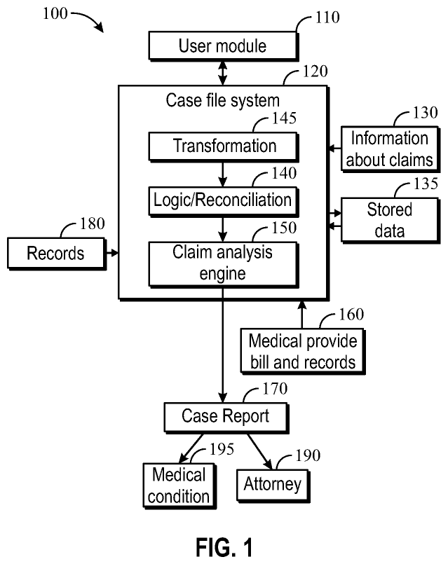

FIG. 1 is a block diagram of a system according to one embodiment.

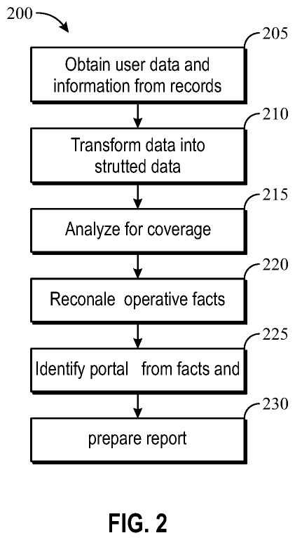

FIG. 2 illustrate a method according to one embodiment.

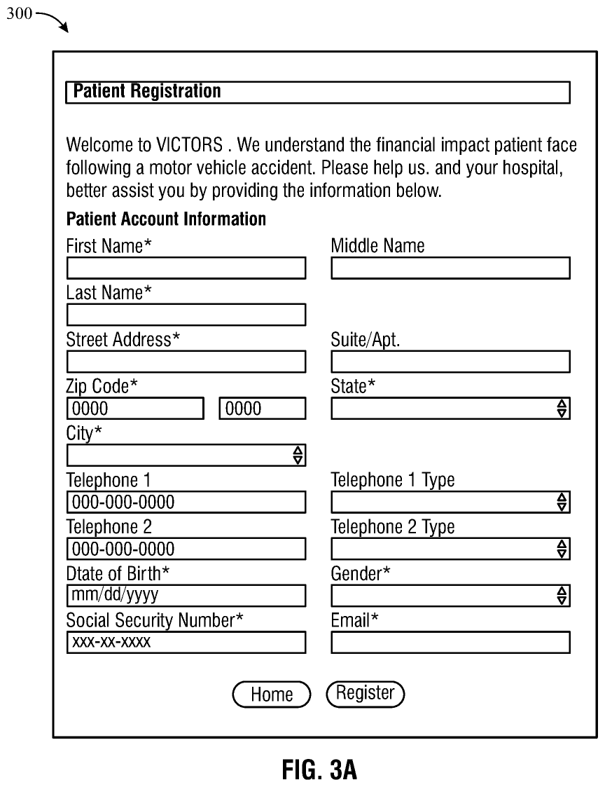

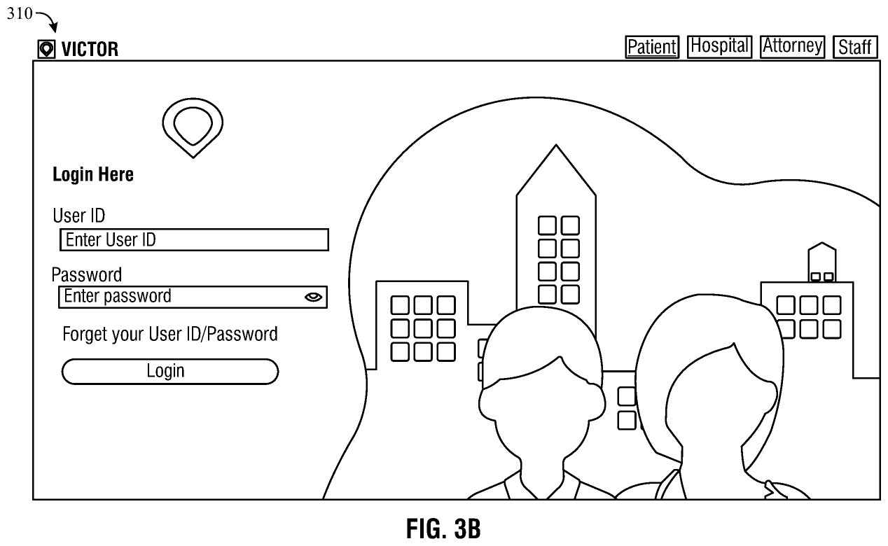

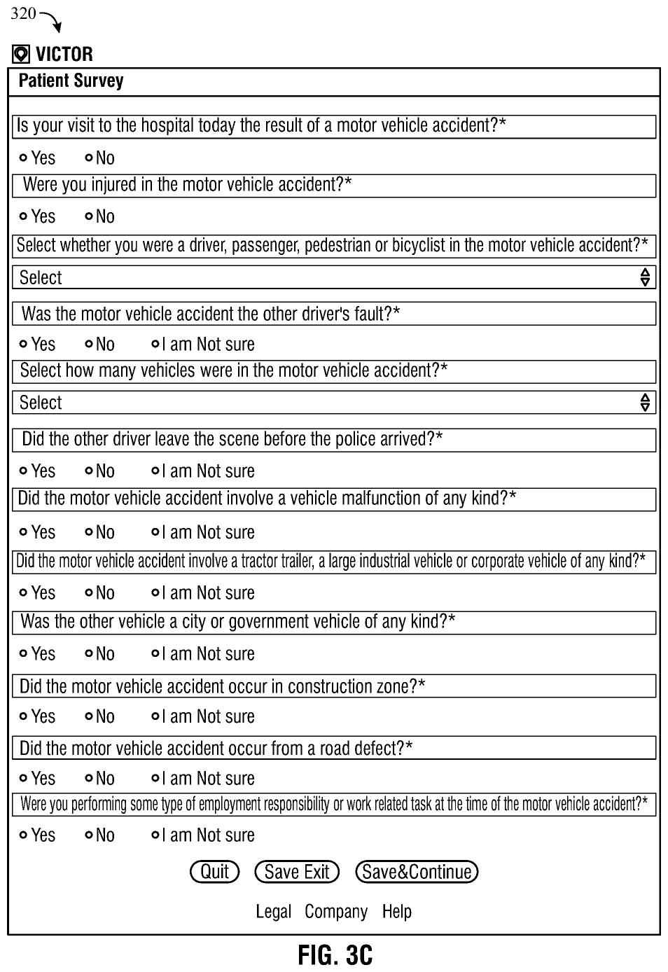

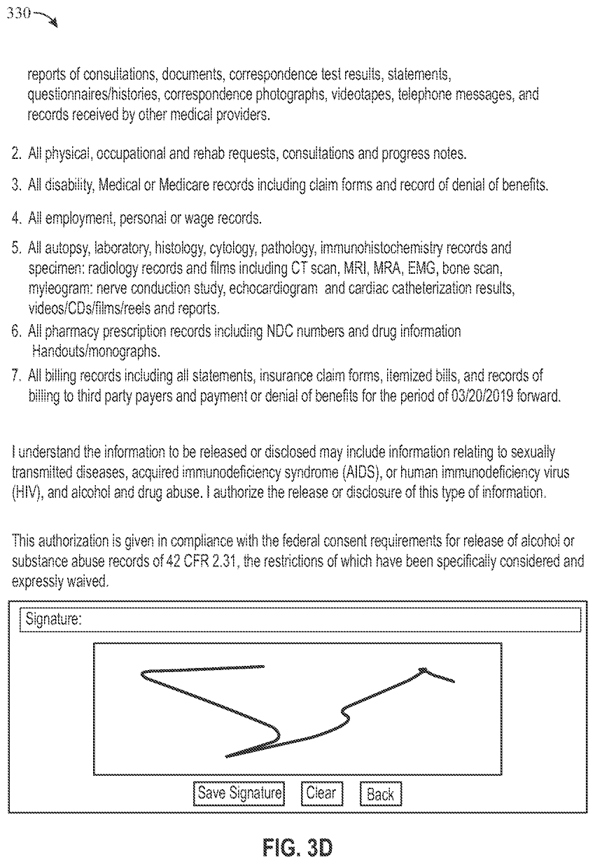

FIG. 3A depicts a screenshot of a browser page loaded on a display of a computing device, including a workflow form and UI control in which the user may establish his or her identity on the system.

FIG. 3B depicts a screenshot of a browser page loaded on a display of a computing device, including a workflow form and UI control in which the user may log onto the system.

FIG. 3C depicts a screenshot of a browser page loaded on a display of a computing device, including a workflow form and UI control in which the user may be surveyed about an accident or injury.

FIG. 3D depicts a screenshot of a browser page loaded on a display of a computing device, including a workflow form and UI control in which the user may agree to certain terms and conditions presented to the user.

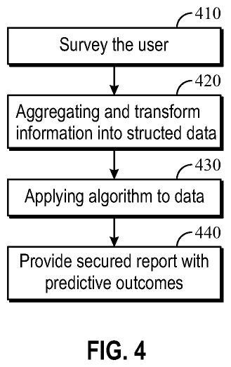

FIG. 4 illustrates a exemplary method according to one embodiment.

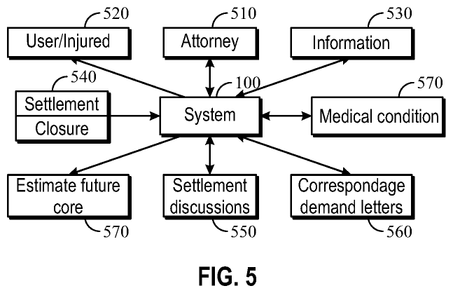

FIG. 5 illustrates an exemplary workflow of the user and an attorney in the context of a casefile in the practice to collect on a claim.

### DETAILED DESCRIPTION

The process of a personal injury case can be lengthy and involves gathering and analyzing information. Embodiments include method and system for preparing and sharing a casefile. Specific embodiments provide a casefile workflow for injury cases, particularly, those in which a third party is responsible. As an illustration, a person who is injured in an auto accident may arrive at the hospital, receive treatment, and then need to pursue a third party or his/own insurance coverage. Specific embodiments transform the difficult task of creating a casefile involving numerous parties, which can be used by an attorney together with the person, to pursue coverage.

The user can be or may a person or persons who have been hurt by a third party or at least a third party is responsible for the paying fees to address the injury. In some examples, the user does not have health insurance and/or may be at the medical facility and have already received treatment. Generally, to file a claim or lawsuit against another party, the aggrieved person must leave the hospital and contact an attorney. The attorney can then start gathering the medical records, the medical bills, the auto repair bills (if any), assess lost wages in the form of user work profiles or user roles, and track the claim for compliance reasons. Often the medical provider or the medical creditor will not get paid until and unless the claim against the third party is resolved.

The systems and methods presented herein may be used to assist a user, such as a consumer or attorney in tracking, managing, and collecting on a personal injury or related claim. The present invention is particularly well suited for assisting a user, such as an injured party, to manage the interaction between the attorney and various information sources. It will be appreciated that the user can include a patient, as well as a designee of the patient, such as a legal designee (e.g., guardian or parent), as well as an advisor of the patient as described herein. Thus, the user can be considered to be anyone capable of using the system described herein to help accomplish a useful, tangible end result. In one example, a legal casefile is electronically prepared using the process and gathered information.

FIG. 1 is a block diagram of a system 100 according to some embodiments of this application. In particular, the system 100 includes casefile system 120 that receives information about an injury claims from various sources (e.g., the user module 110) and documents. For example, such information may be received from medical service provider(s) 160, stored data 135, records 180, or a data storage unit 110.

The user module 110 allows user to interact with the casefile system 120. Further information is queried from and received from the user module 110 in which the inured person accesses and engages. At this user module 110, the user is queried electronically about the relevant situation or accident, signs any relevant releases, and provides details about the injury and situation or accident. The user will also agree, through the user module 110, to various terms and conditions, which will include permission for the system to gather information and to prepare the casefile. The user module 110 is, e.g., a computer, a laptop computer, an enterprise server, or other device capable of connection to the casefile system 120.

The casefile system then begins to collect the information that is useful to analyze the case or liability in the case. Such data can be automatically sourced through online vendor platforms and brought into the system database both as structured data and unstructured data. The unstructured data from records 180 can include reports police reports, motor vehicle reports, ambulance reports, property damage reports doctor and hospital bills, prior medical records, final medical reports, medical reports, and witness statements. In some examples, PDfs of such reports, as unstructured data, are transformed into structured data by extracting each designated field/data point within the report and directly uploaded to a predetermined corresponding field within the casefile system 120 or database. Medical provider data 160 can include PDf or data from medical bills and records and also may be structured data with designated fields/data point within the records and bills such as an HL7 directly uploaded to a predetermined corresponding field within the database. Insurance Data Collection may be in a PDF from an accident report or other record 180; applicable insurance policies can be identified through survey of the user and electronically analyzing the accident report and also structured data of each designated field/data point within the declaration of coverage of each policy directly uploaded to a predetermined corresponding field within the database. The data can be stored and accessed and may reside in a data warehouse 135.

The system 100 may include gathering-type modules to extract specific information from documents. The information 130, the medical provider bills and records 160, and/or other records 180 typically are not uniformly structured and does not have a pre-defined data model or is not organized in a pre-defined manner. The information from these sources is electronically transformed into structured data useful for analysis by a transformation engine 145, which may extract data from unstructured data contained in the document (e.g. a billing record, police report, or client document) and create structured data contained in those document (such as, e.g., titles, name, etc.). Structured data refers to any data that resides in a fixed field within a record or file and which is organized to be useful to prepare a casefile. The documents are then grouped according to this information. This embodiment supports gathering modules that operate differently than described. In accordance with the present application, unorganized (raw) data enters the process only after it has been assembled by automated or manual means into usable information with a definable and automatically recognizable format.

The system 100 may, according to some embodiments, include reconciliation or business logic 140 that automatically determines whether certain information in the system is more or less accurate or credible. For example, if the user indicates he or she had an ankle injury and if the accident was a rear impact collision, the casefile system 120 may indicate that user's data may be less creditable. Specific embodiments may also include historical information that may be used to generate appropriate claims analysis rules to be applied based on the specific facts of the injury claim being work flowed. Untimely, the claims analysis engine 150 produce a report with highlights of case, segmented summary, and highlight strengths and weakness of the case by legal analysis together with data mining. Upon approval of the user, an attorney may review some or all of the case file through an attorney module 190, which may require a fee from either the user or the attorney to the provider of the system 100. Medical creditors, including medical providers, may review some or all of the casefile through a medical creditor module 195, which may require a fee from the medical creditor to the provider of the system 100.

FIG. 2 illustrates an exemplary method 200 according to this application. In one embodiment, a computer-implemented method for preparing and a legal casefile for an injury has the following steps. At 205, querying a user who may have claim against a third party for the injury from motor vehicle accident, surveying the user about the operative facts about the injury and accident, and seeking permission from the user to collect information related to the injury and accident from third party sources. At 210, aggregating the information and transforming the information from the sources into structured data for legal analysis. At 215, analyzing the structured data to determine insurance coverage and to coordinate the insurance coverage. At 220, reconciling the operative facts with the structured data using an algorithm that weights facts based on historical data, historical correlations, and legal principles. At 225, identifying potential liability of the third party from the facts. At 230, creating a report to manage client and case information, to facilitate legal processing of a case against the third party, wherein the report includes liability analysis, insurance coverage, medical information, and medical analysis, wherein the liability analysis include correlations or specific facts in the structured data; the medical information includes correlation or specific medical facts in the structured data.

FIG. 3A illustrates a screen display 300 in which the method or system may begin by the user being provided with a tablet or mobile. The user enters identifying information and establishes a login to the system, which will be used to access the system or method as illustrated in the screenshot 310 in FIG. 3B.

In one example of the embodiment shown in FIG. 2, a computer-implemented method for preparing a legal casefile for an injury, comprising the steps of: querying a user who may have claim against a third party for the injury from motor vehicle accident, wherein the query is through a graphical interface operatively connected to a casefile system; surveying the user about the facts or the operative facts of the injury and accident, wherein the casefile system electronically inquiries into specific details connected with the injury; seeking permission from the user to collect information related to the injury and accident from third party sources, wherein the data is stored by cloud computing or in a data warehouse; aggregating and storing the information in the data warehouse; automatically and electronically transforming the information from the sources into structured data suitable for legal analysis; analyzing the structured data to determine insurance coverage and to coordinate the insurance coverage; reconciling the operative facts with the structured data using an algorithm that weights facts based on historical data, historical correlations, and legal principles; identifying potential liability of the third party from the facts; and creating a report to manage client and case information, to facilitate legal processing of a case against the third party, wherein the report includes liability analysis, insurance coverage, medical information, and medical analysis, wherein the liability analysis include correlations or specific facts in the structured data; the medical information includes correlation or specific medical facts in the structured data.

In some examples, the user can be queried about familiarity with the program or the desire to participate in the program. If the patient/user desires to see information regarding attorney representation within the program they may be provided with a link to a list of available attorneys. The user/patient in this embodiment controls the process and sets process in motion. All required signatures and necessary documentation must be properly signed and saved to the platform.

The user/patient may be asked to sign up will be the creation of an account that can be utilized for a case at a later time or may be utilized at that time. The user/patient can be asked a series of screening questions through the application which will facilitate the collection of information necessary to identify and collect necessary additional data from third parties for further processing. In one example, these requests will be structured data responses (e.g., mostly multiple choice) via the tablet provided at the medical provider or through their mobile device when they are ready to proceed.

T 19. The data collection can begin after the user provides initial information and consent. Central data components can be automatically sourced through online vendor platforms and brought into the system database both as structured data and unstructured data. Accident report data collection includes a PDf of the accident report and also structured data of each designated field/data point within the report which are directly uploaded to a predetermined corresponding field within the Victor database. Medical data collection includes a PDf of the medical bills and records and also structured data of each designated field/data point within the records and bills such as, e.g., an HL7 which are directly uploaded to a predetermined corresponding field within the Victor database. Insurance data collection includes a PDF of applicable insurance policies identified through the survey and on the accident report and also structured data of each designated field/data point within the declaration of coverage of each policy which are directly uploaded to a predetermined corresponding field within the database.

Once the data has been collected, the collected data will be transformed in a new format. The data that is brought in will create new metadata that will be able to be used in a standardized evaluation format for the attorney. In one embodiment, once the system has been able to collect the necessary data and the data has been reorganized and restructured, the restructuring of the data will allow for pre-determined protocols (guided by attorney preference settings) to conduct preliminary issue spotting and reorganize the collected data to assist the attorney in analysis and evaluation. Each of these can be reconciled with new information or attorney/client driven input. For example,
Analysis of liability issues based on combination of collected data and preferred liability strategy approaches based on the given available data. A preliminary analysis of non-medical damages based on collected data from the medical providers and the client. The data has been reorganized and broken down. It will help the attorney and the patient to identify an appropriate strategy/provider for dealing with the non-medical damages. (lost wages/property damages etc.)
Insurance: An evaluation of available insurance coverage compared to the available damages data and other case factors such as liability. This will be presented in the form of a Coordination of Insurance Benefits report.
Medical: A preliminary analysis of medical damages based on collected data from the medical providers and the client. The data has been reorganized and broken down. It will help the attorney and the patient to identify an appropriate strategy/provider for follow-up medical care.
Third Party Lien Audit analysis: Any third-party lien such as a medical provider or an insurer will be audited for error.
Patient Profile: Personal information gathered about the client, such as past injuries, past claims, criminal history and other factors which may play a role in affecting the case outcome.
Documentation: Determination of whether all necessary documentation is appropriately signed and agreed to by the patient.
Case Path: Different analysis will highlight different preferred case paths to choose from. Some cases may be selected to leave the Victor workflow and be handled by a specialized litigation attorney immediately and some will follow a path of building a case file for demand in pre litigation. There may be specific issues such as how to handle follow up care or lost wages as the case progresses.
Decision Support: The system will use the preset attorney determined protocols to conduct preliminary scoring that will help to quantify analysis and help provide statistical and issue driven strategy. There will be both component analysis and overall case reporting available for the attorney to review along with source data.
Strategy Formalization: Different options of case strategy can be agreed upon by the attorney and the client so that the can be some understanding about the nature of representation that the attorney is agreeing to undertake reconciliation/approval: The attorney and the patient are able to choose which direction to take the claim. The software merely facilitates the presentation of the information and communication of this issue.

FIG. 4 illustrates another computerized-method for preparing and a legal casefile for an injury and accident 400, comprising the steps of: surveying the user about the operative facts about the injury and accident 410; aggregating information 420, transforming the information from the sources into structured data for legal analysis, analyzing the structured data to determine insurance coverage and to coordinate the insurance coverage, reconciling the operative facts with the structured data using an algorithm that weights facts based on historical data, historical correlations, and legal principles 430, identifying significant data that include (1) potential liability of the third party from the structured data, (2) follow-up medical care from the structured data, (3) any pain and suffering by the user, and (4) special damages from the structured data, preparing a first report that includes the significant data so that an attorney may confirm the significant facts with the user, and preparing a second report that identifies probability of various financial outcomes based on historical data of settlement and verdicts and based statistical analysis 440.

FIG. 5 shows that the system 100 can be used by an attorney 510 and patient/user/injured 520, either is or both are user(s) to progress through the system. This embodiment includes, e.g., collecting of information or evidence of damages data 530: Based on data collected from the injured, the system 100 can suggest workflows to gather remaining necessary data and evidence to support damages claims that have become available during the case. Further this embodiment can include collection of data on follow-up care or future care 570. Follow-up medical care data 570 shall be gathered in a structured data format similar to the initial medical records and bills gathered at the outset of the process. The follow-up medical records and billing data 530 will be gathered both as a pdf and as structured data automatically uploaded to the system database from the provider as they become available. They can be uploaded as structured data points to predetermined data points within the system. These can be reorganized to a useable format in analysis, reporting, and presentation. As can be seen, the data and documents flow both ways to the system 100. The system 100 can continually obtain documents, update the attorney 510 or injured 520 or the medical creditor 570. Further, the system can track documents, e.g. demand letters 560, and can track settlement discussions 550. Ultimately, if and when the claims settle, the settlement 540 is reported to the system and stored in the data warehouse for future use.

Another embodiment can include the collection information for assessing special damages data. For example, motor vehicle accident personal injury cases include other types of special damages and evidence of these must be gathered. Based on information gathered from the client during the follow-up surveys, specific workflows will be initiated to gather the needed evidence and upload it to the system.

Another embodiment can include a pain and suffering client survey: The patient follow-up surveys can help to collect needed information 530 regarding pain and suffering and similar non-special damages. These responses will allow the information to be sorted and compared to the other evidence gathered in the case such as the medical data and the nature/severity of the accident.

Another embodiment includes data restructuring: All collected data can be restructured. This will allow for processes such as statistical analysis and reformatted presentation for decision making by the attorney and the client.

Another embodiment includes case data summaries. Once the needed data has been gathered and the attorney and injured can enter information triggering case summary analysis workflows are ready to begin the data can be reviewed to allow for the claim to be presented for settlement or other resolution steps.

Another embodiment include analysis: The component scores will be revisited and updated based on attorney defined scoring preferences to help the parties understand the factors in the case and what will be included in the claim and what data points will be excluded as not related or relevant.

Another embodiment includes reconciliation or approval: The analysis can be reviewed by the patient and the attorney for satisfaction and any needed alterations can be made.

Another embodiment includes projections: The data set will allow for a statistics-based analysis of various factors in the case. These will be useful for various aspects of case path strategy decisions.

Another embodiment includes case cost projections: At this time the cost of likely litigation case costs and existing case costs can be made. This information will allow for appropriate decision making by the attorney and the client.

Another embodiment includes statistical outcome analysis: The system can gather statistically significant comparable outcomes of verdicts and settlements in cases within a defined set of data points. This will help the attorney and the client to determine a desired case strategy informed by statistically significant data.

Another embodiment includes comparative case strategy analysis: A side by side comparison of competing statistically likely case strategies will be presented to help the attorney and client make an informed decision on case strategy.

Another embodiment includes case strategy authority: Once the case strategy (e.g., negotiation authority at a particular gross settlement amount and higher) has been agreed to the patient agrees by applying e-signature to the authorization document

One embodiment includes the generation of template documents based on the data collected and the information gathered by the system. This will be generated as an editable automated report based on the case data within the system. This will be sent to the appropriate parties. reconciliation/approval: demand will be able to be communicated to the client via the application and approved or reconciled to satisfaction of the attorney and client.

The workflow or the system may support the negotiation between the adjuster and the attorney. The system can provide documents and store information related thereto.

Another embodiment can include client education support.

Another embodiment can include document and resolving the case proceeds. The workflow documents can help track and document the closing proceeds. Case proceeds distribution: Automated output based on collected data. Lien resolution: workflows can be initiated to aid in the reduction of inappropriate third-party lien amounts that may be required to disburse upon collection of settlement proceed.

Another embodiment is a system and method for the collection, capture, processing, storage, and tracking of data for electronic heath records and billing records based upon a single or multiple data collection instance, and including data collected by electronic medical devices. The health records, medical billing records, and case notes are disorganized and obtain require extensive efforts to sift through and process. Attorneys and consults often spend a significant portion of their time digesting, deciphering, and the organizing the materials in order to manage the case, settle the case, or try the case. The information or knowledge used in this process includes documents of interest to users, which may be in any form, such as but not limited to text, images, graphics, audio, video, multimedia, computer programs/applications, etc., and combinations thereof.

One basic embodiment of this disclosure is a method and system for preparing a casefile for a personal injury for use for lawyer or consultant. In a basic embodiment, the method and system (1) aggregates medical records, medical billing and coding, patient input, public records, and attorney data; (2) structures the data from these sources into structured data; (3) creates a casefile to effectively managing client and case information, including contacts, calendaring, documents, and other specifics by facilitating processing and six sigma practices in law practices. The results are reduced time and mistakes in the course of case practice and/or trial.

In one example, internal data structure fields are also be used for (but are not limited to): (3) storing computerized text including generated medical codes, computerized text generated from check boxes and other information extracted from the patient encounter information that is displayed at various locations in one or more electronic templates such as the electronic invoice electronic medical record, or other information.

In one example, a follow up client survey: Survey will be structured data responses through their mobile device or computer device when they are ready to proceed which will help collect further information that will be helpful to the attorney in analyzing the case. In accordance with another embodiment, the delivery system of this application holds data, documents, and images, as well as files such as Word or Access transaction. These files and other objects may include specific index information to allow them to be more readily identified to the user. Documents may be grouped and organized in a fashion that process the case from a complaint stage, discovery stage, expert report stage, and ultimately to trial and appeal.

Certain embodiments provide a number of functions for processing and manipulating information and data from records. Generally, the functions that are performed are selected by users, who legal consultants or lawyers. The concept of a “workflow” is the concept that functions are performed in a sequence and in some cases the work flow is more efficient.

System content can be managed by integrating an attorney's Document Management System (“DMS”) or other workflow system into system. Such integration permits a client to directly publish content to a website generated by system. FIG. depicts the flow of such publication. As depicted, in step 1, content authors upload or otherwise create content in client DMS. Attorneys can tag content to specify who has permission to view the content. A communication link is then established between client DMS and an online receiver of system 100 to upload the content to system 100.

The integration of data between systems may provide substantial benefits to the workflow for different types of users involved in the prosecution and handling of a claim against a third party. In accordance with some embodiments, the hospital may share data with the central system related to patient's or claimant's details, addresses, bills, and medical records. The system may share data with the hospital related to attorney recruitment and progress, settlement demands and collections. By integrating data between the medical facility and the system in accordance with some embodiments, redundant steps of data entry may be eliminated and the efficiency of case management may be improved substantially.

One embodiment allows a user to gather information and documents that allow him or her to assist his or her attorney with the case against the third party. For example, the user will search for attorneys and potentially present the files to the attorney for evaluation of the case against the third party.

Another embodiment includes case evaluation by the system and agents. The system may include statistical prediction based on data points (e.g., liability, damages, pain and suffering, etc evaluated and scored as component and collectively statistically and highlighted for attorney as decision support). As more data is collected, the system can improve it predictions. This outcome analysis for the attorney to review in order to decide whether to take the case.

Another embodiment may include form documents for an attorney. In this arrangement, the attorney could generate documents based on the data gather by the system. This aids in the efficient prosecution of cases.

Another embodiment includes distribution of access to the casefile application by a medical provider and/or through Medical Provider: The application for personal injury claim support can be distributed through various means, through benefit plans, free download within certain markets, and through medical providers. This embodiment can help ensure that deductibles and injury claims are recovered by the plans or the medical providers.

The business logic engine contains the system logic for running the integrated applications described above. Moreover, business logic engine can identify information stored for example, in layer in response to a user request. For example, business logic engine can retrieve information relating to financial and health accounts of a user, each account being associated with a corresponding financial or health institution. The business logic engine also includes means (e.g., software) for generating a set of information based upon the financial and health data. A resulting amalgamation of the financial and health data can be sent through the web interface to be displayed to the user or attorney, for example, or can be embodied into an alert, if desired, and sent to the user.

The predictive model, in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the insurance company. The specific data and outcomes analyzed vary depending on the desired functionality of the particular predictive model. The particular data parameters selected for analysis in the training process are determined by using regression analysis and/or other statistical techniques known in the art for identifying relevant variables in multivariable systems. The parameters can be selected from any of the structured data parameters stored in the present system, whether the parameters were input into the system originally in a structured format or whether they were extracted from previously unstructured text.

An algorithm in data mining (or machine learning) is a set of heuristics and calculations that creates a model from data. To create a model, the algorithm first analyzes the data provided, looks for specific types of patterns or trends. The algorithm uses the results of this analysis over many iterations to find the optimal parameters for creating the mining model. These parameters are then applied across the entire data set to extract actionable patterns and detailed statistics. The mining model that an algorithm creates from the data can take various forms, including: A set of clusters that describe how the cases in a dataset are related. A decision tree that predicts an outcome, and describes how different criteria affect that outcome. A mathematical model that forecasts sales. A set of rules that describe how products are grouped together in a transaction, and the probabilities that products are purchased together. In this application, segmentation algorithms are particularly useful.

There are types of algorithms. Classification algorithms predict one or more discrete variables, based on the other attributes in the dataset. Regression algorithms predict one or more continuous numeric variables, such as profit or loss, based on other attributes in the dataset. Segmentation algorithms divide data into groups, or clusters, of items that have similar properties. Association algorithms find correlations between different attributes in a dataset. The most common application of this kind of algorithm is for creating association rules, which can be used in a market basket analysis. Sequence analysis algorithms summarize frequent sequences or episodes in data, such as a series of clicks in a web site, or a series of log events preceding machine maintenance.

The terms medical record, health record, and medical chart are used somewhat interchangeably to describe the systematic documentation of a single patient's medical history and care across time within one particular health care provider's jurisdiction. The medical record includes a variety of types of “notes” entered over time by health care professionals, recording observations and administration of drugs and therapies, orders for the administration of drugs and therapies, test results, x-rays, reports, etc. The maintenance of complete and accurate medical records is a requirement of health care providers and is generally enforced as a licensing or certification prerequisite. The terms are used for both the physical folder that exists for each individual patient and for the body of information found therein. Medical records have traditionally been compiled and maintained by health care providers, but advances in online data storage have led to the development of personal health records (PHR) that are maintained by patients themselves, often on third-party websites. Medical billing and coding are two closely related aspects of the modern health care industry. Both practices are involved in the immensely important reimbursement cycle, which ensures that health care providers are paid for the services they perform. Medical coding, at the most basic concept, is a little like translation. It's the coder's job to take something that's written one way (a doctor's diagnosis, for example, or a prescription for a certain medication) and translate it as accurately as possible into a numeric or alphanumeric code. For every injury, diagnosis, and medical procedure, there is a corresponding code. On one level, medical billing is as simple as it sounds: medical billers take the information from the medical coder and make a bill for the insurance company, called a claim. Of course, as with everything related to the health care system, this process isn't as simple as it seems.

Legal practice and case management software generally can provide attorney with a convenient method of effectively managing client and case information, including contacts, calendaring, documents, and other specifics by facilitating automation in law practices. It can be used to share information with other attorneys in the firm and will help prevent having to enter duplicate data in conjunction with billing programs and data processors. Many programs link with personal digital assistants (PDAs) so that calendars and schedules are always handy. Some case management packages are Web-based, with more on the way, allowing anytime access to all features.

Legal principles are the general principle of law or general legal principle refers to a principle that is recognized in all kinds of legal relations in the United States. It can also be a principle that is widely recognized by people whose legal order has attained a certain level of sophistication.

“Medical creditor” is a term used to identify the entity or person who owns the debt for the care given to the injured party. The medical creditor may be a hospital or medical office. It may also be an entity or person that acquired the debt for the car given.

“Cloud computing” is a term used to identify the delivery of computing requirements as a service to a heterogeneous community of end-recipients. The term cloud theoretically signifies abstraction of technology, resources and locations that are used in building an integrated computing infrastructure (including networks, systems, applications, etc.). All Cloud computing models rely heavily on sharing of resources to achieve coherence and economies of scale similar to a utility (like a grid for electricity) over a network.

Embodiments can be operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

While various embodiments of this invention have been described above, it should be understood that they have been presented by way of example only. The breadth and scope of this invention should not be limited by any of the exemplary embodiments.

1. A computer-implemented method for preparing a legal casefile for an injury, comprising the steps of:
a. querying a user who may have claim against a third party for the injury from motor vehicle accident, wherein the query is through a graphical interface operatively connected to a casefile system;
b. surveying the user about the operative facts about the injury and accident, wherein the casefile system electronically inquiries into specific details connected with the injury;
c. seeking permission from the user to collect information related to the injury and accident from third party sources, wherein the data is stored by cloud computing or in a data warehouse;
c. aggregating and storing the information in the data warehouse;
d. automatically and electronically transforming the information from the sources into structured data suitable for legal analysis;
e. analyzing the structured data to determine insurance coverage and to coordinate the insurance coverage;
f. reconciling the operative facts with the structured data using an algorithm that weights facts based on historical data, historical correlations, and legal principles;
g. identifying potential liability of the third party from the facts; and
h. creating a report to manage client and case information, to facilitate legal processing of a case against the third party, wherein the report includes liability analysis, insurance coverage, medical information, and medical analysis, wherein the liability analysis include correlations or specific facts in the structured data; the medical information includes correlation or specific medical facts in the structured data.

2. The method of claim 1, wherein the user is surveyed about past injuries, past accident claims, and past aliments.

3. The method of claim 1, wherein the user is surveyed about whether the accident and injuries occurred within scope of employment.

4. The method of claim 1, wherein the legal analysis from the plaintiff's perspective.

5. The method of claim 1, wherein the information includes medical records, medical billing, medical coding, patient input, public records, and combinations thereof.

6. The method of claim 1, further comprising querying the user about whether the user is interested in reviewing a list of attorneys based the operative facts.

7. The method of claim 1, wherein the information is aggregated through APIs.

8. The method of claim 1, further comprising having the user apply to use the method by agreeing terms and conditions, wherein the terms and conditions include releases.

9. The method of claim 1, wherein a first set of information is collected on the application and includes information selected from the group consisting of an account number, a telephone number, a date, an electronic mail address and combinations thereof.

10. The method of claim 1, further comprising forwarding or allowing access the legal casefile to the attorney.

11. The method of claim 1, wherein the user provides consent to allow a medical creditor to follow the status of the case against the third party.

12. The method of claim 1, wherein the attorney pays a fee to use the casefile.

13. The method of claim 1, wherein the user is the claimant or plaintiff against the third party.

14. The method of claim 1, further comprising connecting with an attorney's DMS to obtain documents to stored as part of the casefile.

15. A computerized-method for preparing and legal casefile for an injury and accident, comprising the steps of:
a. surveying the user through a graphical interface about the operative facts about the injury and accident; wherein the casefile system electronically inquiries into specific details connected with the injury
b. electronically aggregating and storing information in a data warehouse, wherein the data is stored by cloud computing or in a data warehouse;
c. automatically and electronically transforming the information from the sources into structured data for legal analysis,
d. analyzing the structured data to determine insurance coverage and to coordinate the insurance coverage,
e. reconciling the operative facts with the structured data using an algorithm that weights facts based on historical data, historical correlations, and legal principles,
f. identifying significant data that include (1) potential liability of the third party from the structured data, (2) follow-up medical care from the structured data, (3) any pain and suffering by the user, and (4) special damages from the structured data,
g. preparing electronically a first report that includes significant data so that an attorney may confirm the significant facts with the user, and
h. preparing electronically a second report that identifies probability of a financial outcome based on historical data of settlement and verdicts and based statistical analysis.

16. The method of claim 15, further comprising estimating case costs of a case against the third party.

17. The method of claim 16, further comprising identifying witnesses from the structured data.

18. The method of claim 17 further comprising comparing the case costs with the outcome.

19. The method of claim 15, wherein the legal analysis from the plaintiff's perspective.

20. The method of claim 16, wherein the information includes medical records, medical billing, medical coding, patient input, public records, and combinations thereof.

21. The method of claim 16, further comprising querying the user about whether the user is interested in reviewing a list of attorneys based the operative facts.

22. The method of claim 15, wherein the information is aggregated through APIs.

23. The method of claim 14, further comprising having the user apply to use the method by agreeing terms and conditions, wherein the terms and conditions include releases.

24. A processing system including provisions to execute a document workflow for a legal casefile processing, comprising the steps of:
a. user module
b. a casefile system having a data transformation tool, a logic or reconciliation tool and a claims algorithm engine
c. a case report module,
wherein the system stores computerized text including generated medical codes, computerized text generated from check boxes and other information extracted from the patient encounter information that is displayed at various locations in one or more electronic templates such as the electronic medical record.
